(19) United States
(12) Patent Application Publication
(10) Pub. No.: US 2018/0285918 A1
(43) Pub. Date: Oct. 4, 2018

(54) ADVERTISING INCENTIVES

(71) Applicant: Tyler Staggs, Beverly Hills, CA (US)

(72) Inventor: Tyler Staggs, Beverly Hills, CA (US)

(21) Appl. No.: 15/941,631

(22) Filed: Mar. 30, 2018

Related U.S. Application Data
(60) Provisional application No. 62/479,715, filed on Mar. 31, 2017.

(51) Int. Cl. G06Q 30/02; G06Q 30/00

(52) U.S. Cl. CPC G06Q 30/0236; G06Q 30/018; G06Q 30/0241

(57) ABSTRACT

An advertising incentive system provides incentives for users to view and provide feedback regarding advertisements. An advertisement is displayed for viewing by a user, and the user's viewing of the advertisement is verified. Based on the verification, an incentive such as a sweepstakes entry is provided to the user. The user may further provide feedback regarding the advertisement, and in response to so doing receive additional incentives, such as additional sweepstakes entries.

### CROSS-REFERENCE TO RELATED APPLICATION

This application claims the benefit of U.S. Provisional Patent Application No. 62/479,715, filed on Mar. 30, 2017, the contents of which are incorporated by reference.

### BACKGROUND

Advertisers spend a great deal of time and effort preparing advertisements for consideration by consumers. Direct feedback regarding advertisements is desirable for determining the consumers' response to the advertisements and for improving the ability to convert advertising into sales, but are often difficult to achieve efficiently and effectively.

### SUMMARY

In accordance with certain aspects of the present disclosure, methods and systems provide incentives for people to watch, interact with, and provide feedback regarding advertising. In some examples, the primary incentive is the prospect of winning a substantial cash or other prizes in one of a series of periodic advertising sweepstakes. For example, a method includes receiving a registration by a user, displaying an advertisement for viewing by the user, verifying the user's viewing of the advertisement, and based on the verification, providing an incentive to the user. As noted above, in some implementations the incentive may include the prospect of winning a prize in a sweepstakes.

### BRIEF DESCRIPTION OF THE DRAWINGS

FIG. 1 is a block diagram illustrating aspects of an example ad sweepstakes service system.

FIG. 2 is a flow diagram illustrating an example of an advertising viewing incentive process.

FIG. 3 is a flow diagram illustrating further aspects of the process shown in FIG. 2.

FIG. 4 is a flow diagram illustrating aspects of an example of a user registration process shown in FIG. 3.

FIG. 5 is a flow diagram illustrating an example of an advertising viewing incentive process using third party platforms for displaying advertisements.

FIG. 6 is a flow diagram illustrating an example of an incentive sweepstakes process.

FIG. 7 is a flow diagram illustrating another example of an incentive sweepstakes process.

FIG. 8 is a block diagram illustrating portions of an example computer system.

### DETAILED DESCRIPTION

In the following Detailed Description, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense.

Advertisements (or “ads”) are displayed using a variety of media, such as print, radio, television, and more and more via the internet. Receiving feedback on advertisements and confirming ad viewership is important to advertisers to assess the effectiveness of ads, for example. Additionally, providing a path for a direct connection between advertisers and potential customers helps advertisers determine the consumers' response to ads. Aspects of this disclosure provide incentives for people to watch, interact with, and provide feedback regarding advertising and offer an opportunity to request further information or otherwise engage with advertisers. In some examples, the incentives to provide the feedback include winning a prize in one of a series of periodic advertising sweepstakes. For instance, if the prize includes cash, the amount of prize money would be determined at the beginning of each sweepstakes and would be funded by a share of the advertising revenues generated by the service. To the extent other prizes are awarded, these also would be determined at the beginning of each sweepstakes.

In order to obtain entries into the sweepstakes, a user would initially register with the ad sweepstakes service. After creating an account, the user would receive discreet sweepstakes entries by watching ads on an ad sweepstakes service website or mobile application, for example, or on other applications, websites or other media where an advertiser has an established arrangement with the ad sweepstakes service.

To receive a valid sweepstakes entry, a user would verify their viewing of an ad by responding to a query from the ad sweepstakes service by various other media. In some examples, a user additionally receives additional sweepstakes entries by providing feedback regarding an advertiser's product, service, or the ad itself. That feedback could also provide an opportunity for users to request direct follow-up from advertisers or click through to advertisers, thereby providing direct sales leads. Such incentives could be provided for ads displayed using other forms of media, such as by media not directly connected to the internet or other communications networks. For example, a print ad may include a QR code that a user can scan or capture on a smart device, providing a link to the ad sweepstakes service allowing the user to verify the ad viewing and possibly provide feedback. The QR code could further provide a link to the advertisers. Live viewing of advertising on television programming, for example, could be verified using a simultaneous connection to the ad sweepstakes service application or site. In some instances, that simultaneous connection could be triggered by an inaudible cue or other means of connection between a television and the smart device.

Incentives provided by the ad sweepstakes services potentially would increase advertising viewership and engagement and provide valuable feedback to advertisers, all of which can substantially increase the value of advertising both on the ad sweepstakes service site and through a variety of media.

This increase in value would benefit advertisers and the media on which the ads are run, as well as funding the sweepstakes prizes.

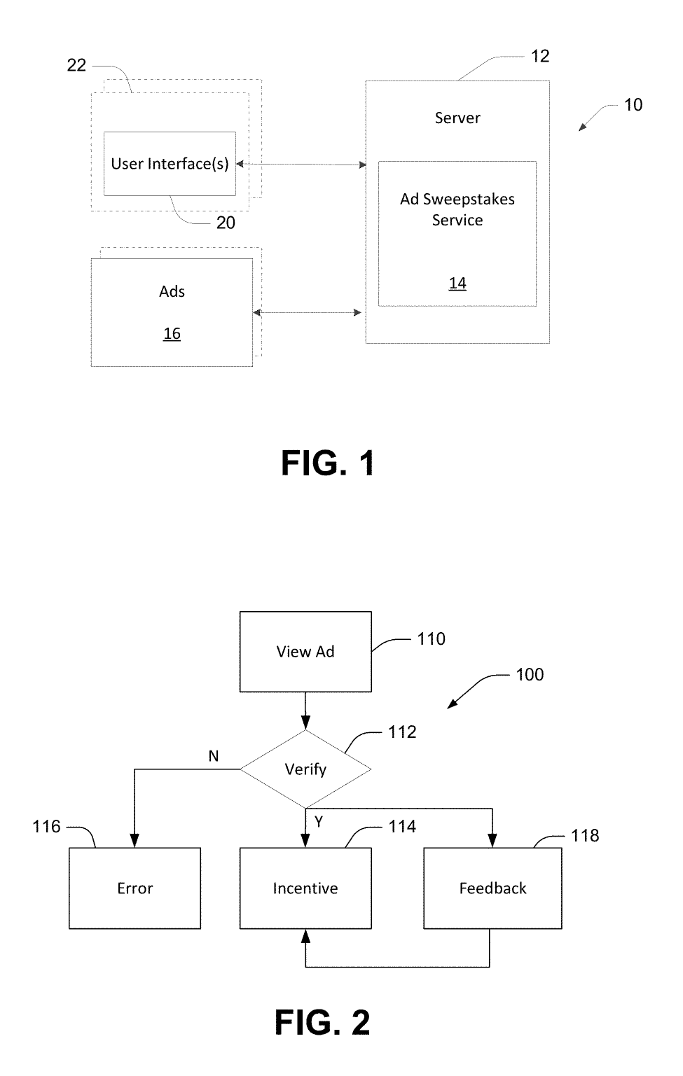

FIG. 1 is a block diagram illustrating an example system 10 that includes a computer 12 implementing ad sweepstakes service 14 in accordance with disclosed embodiments. In some examples, the computer 12 is a server computer that may be implemented by one or more computer systems. The computer 12 communicates with users, for example, over a network such as the internet. The computer 12 generates suitable user interfaces 20 configured to display ads 16 for the user and receive information from the user, such as verification of ad viewing and feedback regarding viewed ads. Ads 16 typically are provided by advertisers who register with the ad sweepstakes service, for example, via additional user interfaces 20 generated by the computer ad sweepstakes service 14. The ads may be stored in various databases accessible by the computer 14. The user interfaces 20 could be implemented on any suitable user computer device 22, such as a desktop computer, laptop computer, tablet device, smart phone, television, game console, etc. that communicates with the computer 12, for example, via a network such as the internet. In other examples, the user interface 20 could be implemented by multiple user devices 22, for instance, in situations where an ad 16 is displayed on one medium such as a television or laptop computer, while another medium such as a smart phone provides the verification and feedback loop.

FIG. 2 is a flow diagram generally illustrating aspects of an example of an advertising sweepstakes process 100. In general, a user views an ad at operation 110. After or while viewing the ad, a verification process is executed, and if the ad viewing is verified at operation 112, an incentive 114 is provided. If the verification is not confirmed at operation 112, for example, an error message 116 may be displayed on the user interface 20. Additionally, the user may provide feedback 118 regarding the viewed ad, and based thereon receive further incentives. In certain implementations, the incentives 114 include one or more entries into a sweepstakes.

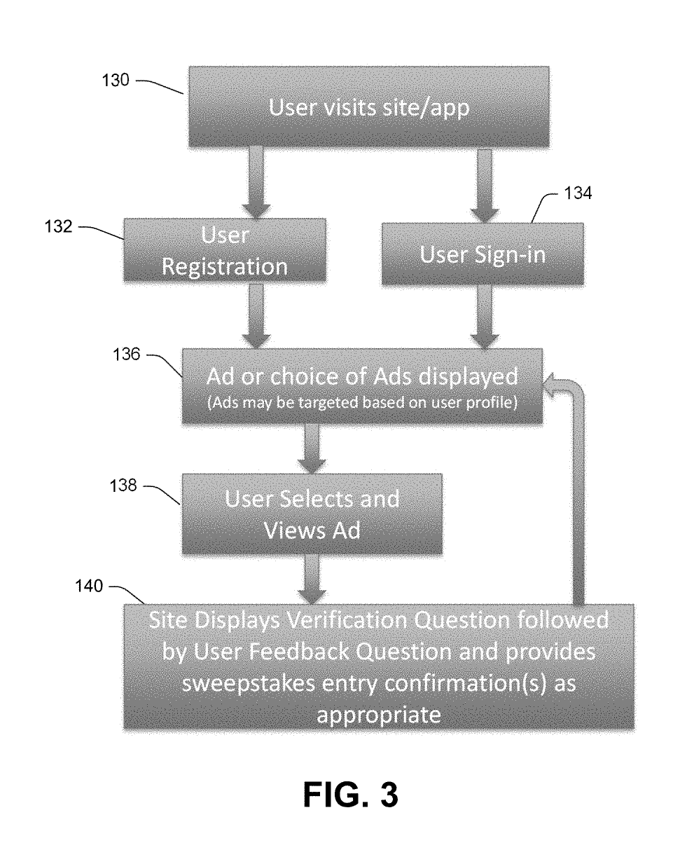

FIG. 3 illustrates further aspects of the process 100 shown in FIG. 2. At operation 130, a user visits the ad sweepstakes service app or web site, for example, via the user interface 20. If the user has not previously registered with the service, they register at operation 132. Previously registered users sign into the system at operation 134. Once logged into the service, an ad or a list of ads is displayed for the user. In some versions, the ads may be targeted to the specific user based on information gathered during the user registration process 132. The ad is viewed by the user at operation 138, and verified at operation 140. In the illustrated example, the verification process includes displaying one or more verification questions on the user interface 20.

The verification question(s) will both confirm that an actual person viewed the ad and reinforce the connection between the ad and the advertiser. For example, the verification question may consist of a choice of four logos consisting of the logo of the company advertised in the ad and three made-up logos. The user would be asked to correctly identify the logo of the advertised company in order to receive the incentive—a sweepstakes entry. More than one wrong answer in a single session will freeze out the user for a period of time, for example. After correctly answering the verification question, the user would have the option to answer a user feedback question to receive an additional sweepstakes entry.

An example of a User Feedback Question is as follows:
Select all that Apply:
   I enjoyed the advertisement
   The advertisement was clear and helpful
   I am interested in the product/company and would like more information
   I am not interested in this product/company

Advertisers will be able to provide their own user feedback options, which may be stored in a database accessible by the server computer 12. As noted above, users responding to the advertiser feedback question may receive another sweepstakes entry.

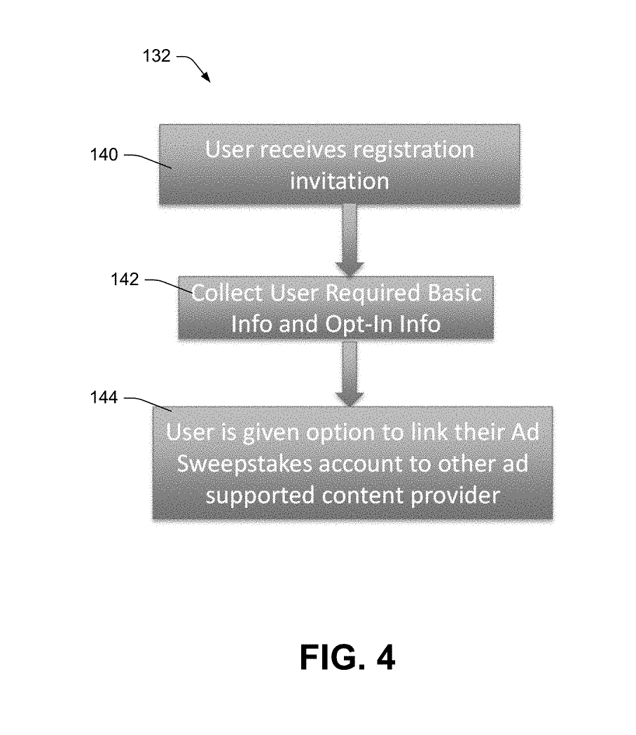

FIG. 4 illustrates aspects of an example of the user registration process 132. At operation 140, a new user receives a registration invitation. In some embodiments, the user receives the invitation either by visiting the website or downloading the application. At operation 140, user information is collected. Basic information includes, for example, standard information that establishes a new user and their eligibility based on age and geography, among other things. Opt-in information may be provided at the user's discretion, and may include information to better target advertisements and to increase user value to advertisers (e.g. household income, interests, etc.).

At operation 144, the user is given an option to link their ad sweepstakes account to selected advertisement or ad supported content providers who have a previously-established relationship with the ad sweepstakes service. In this manner, the user has the opportunity to gain sweepstakes entries through viewership on other ad-supported media, enhancing the value of those advertisements (and increasing the potential prize opportunity for the users) while also providing an additional set of opportunities for the user and the advertiser to interface directly with one another.

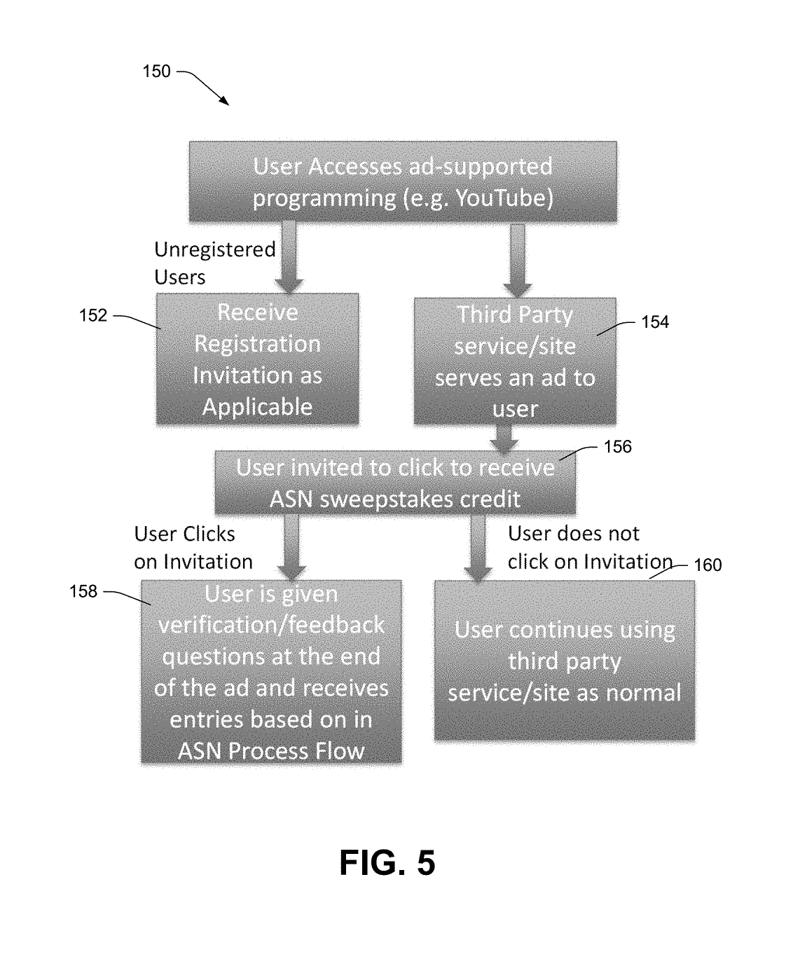

In some implementations, ads may be displayed for a user via third party providers and platforms. For example, ads could be displayed on a third party web site or application, such as Youtube. FIG. 5 shows an example process flow for such embodiments. At process 150, the user accesses ad-supported programming on a third party platform such as Youtube or a television station's web site or app. At operation 152, a new user receives a registration invitation. User invitations to register with the ad sweepstakes service could be based, for example, on agreements between the ad sweepstakes service and the third party providers. Users opting not to register for the ad sweepstakes service at operation 152 would continue to use the third party service as normal as in operation 160. Alternatively, in some embodiments, unregistered users are given an option to gain provisional sweepstakes entries subject to completing valid registration within a predefined period of time. Entering a valid email address, for example, could provide this option to the user. If the user opts to register in response to the invitation at operation 152, the user may register in accordance with the process 132 discussed above.

In operation 154, an ad is displayed for the registered user via the third party platform. In operation 156, the user is invited to receive an incentive for viewing the ad, and if the user accepts this invitation, at process 158 the user is given verification/feedback questions at the end of the ad and potentially receives sweepstakes entries in accordance with processes described herein above. If the user chooses not to accept the invitation of process 156, the user continues using the website as normal in operation 160. In some examples, the ad is displayed on a television, such as during the normal course of television programming. Various methods may be employed for receiving the user feedback. For instance, the television may be configured to signal a mobile device of the user, such as the user's smart phone, at the end of the ad, and thereafter, provide the invitation of process 156 to receive feedback. In some embodiments, the signal from the television includes an audio signal (typically out of the hearing range of a human) that is received by the user's device.

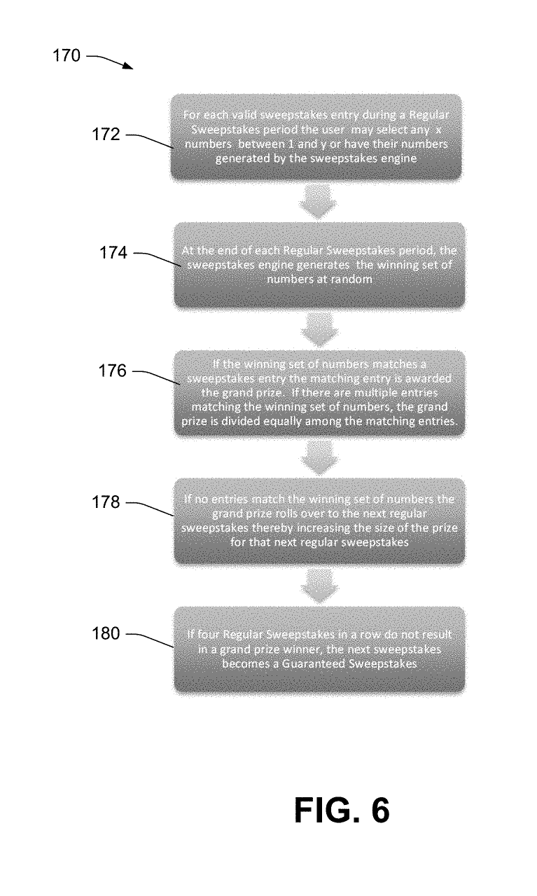

FIG. 6 illustrates an example sweepstakes process 170 provided as an incentive to view and/or provide feedback regarding advertisements. In some examples, each sweepstakes entry provided for viewing ads and/or providing feedback regarding viewed ads is of equal value and constitutes a separate and equal opportunity to win one or more prizes. In other implementations, users may also have an opportunity to receive a double entry instead of a standard single entry at each junction where receiving a single entry is possible. This double entry is awarded randomly and regularly and gives users two numbers in appropriate the sweepstakes instead of one. In still further examples, the number of valid entries may be limited. This has the potential to provide better, more valid feedback data, since a single user would not be providing a large number of responses for a given ad.

At operation 172, a user is allowed to select a predetermined number of sweepstakes numbers. For example, for each valid sweepstakes entry received during a sweepstakes period, the user may select any x numbers between 1 and y (x and y are positive integers), or have sweepstakes numbers generated by the sweepstakes engine. In operation 174, a winning set of numbers is randomly generated. This occurs, for example, at the end of predefined sweepstakes periods. If, as determined in operation 176, randomly generated winning set of numbers matches a sweepstakes entry, the user corresponding to the matching entry is awarded the grand prize. If there are multiple sweepstakes entries matching the winning set of numbers, the grand prize is divided equally among the matching entries. In some examples, lesser prizes are awarded for partial matches of the winning set of numbers. In operation 178, if no entries match the winning set of numbers, the grand prize rolls over to the next regular sweepstakes period, thereby increasing the size of the prize for that next regular sweepstakes. In the illustrated example, if a predetermined number of consecutive sweepstakes do not result in a winner as determined in operation 180, the next sweepstakes becomes a guaranteed sweepstakes. In the example shown in FIG. 6, a sweepstakes becomes a guaranteed sweepstakes if four consecutive sweepstakes do not result in a winner.

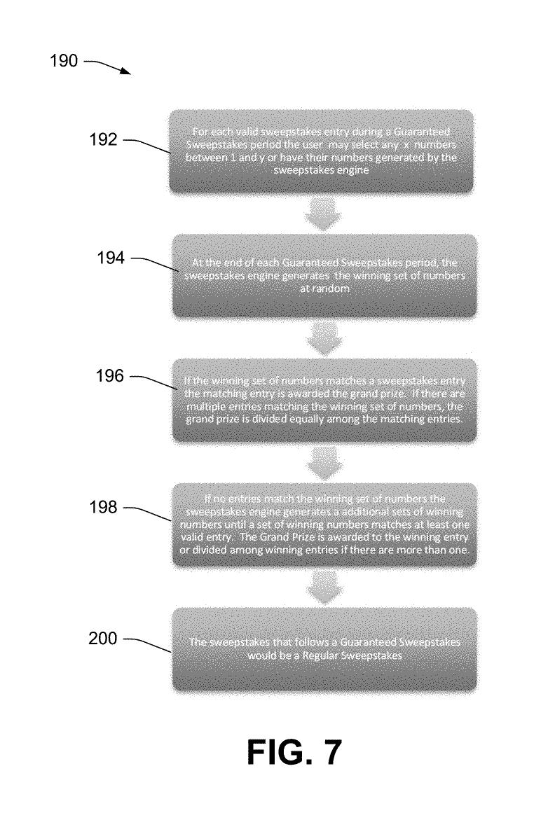

FIG. 7 illustrates an example of a guaranteed sweepstakes process 190. As with the sweepstakes process illustrated in FIG. 6, each sweepstakes entry provided for viewing ads and/or providing feedback regarding viewed ads is of equal value and constitutes a separate and equal opportunity to win one or more prizes. Also similarly to the process shown in FIG. 6, the user is allowed to select a predetermined number of sweepstakes numbers at operation 192, such as any x numbers between 1 and y (x and y are positive integers), or the user may have the sweepstakes numbers generated by the sweepstakes engine. In operation 194, a winning set of numbers is randomly generated at the end of the predefined sweepstake periods. In operation 196, if the randomly generated winning set of numbers matches a sweepstakes entry, the user corresponding to the matching entry is awarded the grand prize. If there are multiple sweepstakes entries matching the winning set of numbers, the grand prize is divided equally among the matching entries. In some examples, lesser prizes are awarded for partial matches of the winning set of numbers. If in operation 198, if no entries match the winning set of numbers, additional sets of winning numbers are generated until a set of winning numbers matches at least one sweepstakes entry. The grand prize is then awarded to the winning entry or divided among winning entries if there are more than one. As shown in operation 200, the sweepstakes that follows a guaranteed sweepstakes would be a regular sweepstakes as illustrated, for example, in FIG. 6.

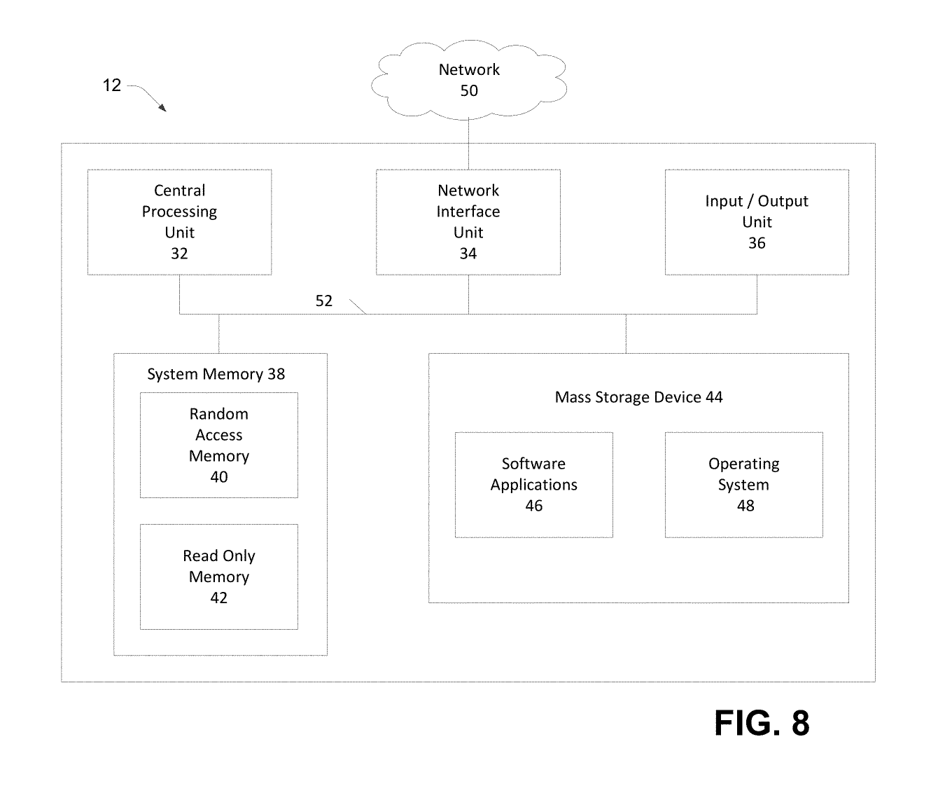

FIG. 8 schematically illustrates an example of the computer 12, which as noted above could be a server computer communicating with various advertisers, users, and third party platforms via networks such as the internet. The example computer 12 includes at least one processor (“CPU”) 32, a system memory 38, and a system bus 52 that couples the system memory 38 to the CPU 32. The system memory 38 includes a random access memory (“RAM”) 40 and a read-only memory (“ROM”) 42. A basic input/output system that contains the basic routines that help to transfer information between elements within the server computer 12, such as during startup, is stored in the ROM 42. The server computer 12 further includes a mass storage device 44. The mass storage device 44 is able to store software instructions and data, including software instructions configured to execute the ad sweepstakes services processes described herein. A processor, system memory and mass storage device similar to that shown in FIG. 8 are also included in each of the devices 22 providing the user interfaces 20.

The mass storage device 44 is connected to the CPU 32 through a mass storage controller (not shown) connected to the system bus 52. The mass storage device 44 and its associated computer-readable data storage media provide non-volatile, non-transitory storage for the server computer 12. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server computer 12.

According to various disclosed embodiments, the server computer 12 may operate in a networked environment using logical connections to remote network devices through the network 50, such as a wireless network, the Internet, or another type of network. The server computer 12 may connect to the network 50 through a network interface unit 34 connected to the system bus 52. It should be appreciated that the network interface unit 34 may also be utilized to connect to other types of networks and remote computing systems. The server computer 12 also includes an input/output controller 36 for receiving and processing input from a number of other devices, including a touch user interface display screen, or another type of input device. Similarly, the input/output controller 36 may provide output to a touch user interface display screen or other type of output device.

As mentioned briefly above, the mass storage device 44 and the RAM 40 of the server computer 12 can store software instructions and data. The software instructions include an operating system 48 suitable for controlling the operation of the server computer 12. The mass storage device 44 and/or the RAM 40 also store software instructions, that when executed by the CPU 32, cause the server computer 12 to provide the functionality of the computer 12 discussed herein. For example, the mass storage device 44 and/or the RAM 40 can store software instructions that, when executed by the CPU 32, cause the server computer 12 to implement the ad sweepstakes service 14 shown in FIG. 1 for applying the various processes described herein, among other things.

In some embodiments, user feedback on advertisements is stored in a database, which could be implemented, for example, via the mass storage device 44 or any other suitable computer memory. Collecting this direct data allows creating a profile for individual participants that can then be used to create a more detailed profile of the user, create more effective advertisement targeting, give greater context for the feedback to allow providing advertisers a more macro view on the people who respond in specific ways to their advertisements, etc.

Various modifications and alterations of this disclosure may become apparent to those skilled in the art without departing from the scope and spirit of this disclosure, and it should be understood that the scope of this disclosure is not to be unduly limited to the illustrative examples set forth herein.

What is claimed is:

1. A method, comprising:
receiving a registration by a user;
displaying an advertisement for viewing by the user;
verifying the user's viewing of the advertisement; and
based on the verification, providing an incentive to the user.

2. The method of claim 1, wherein the advertisement is provided by a third party content provider, and wherein displaying the advertisement includes establishing a connection between the user and the third party content providers.

3. The method of claim 1, wherein the incentive includes a sweepstakes entry.

4. The method of claim 1, further comprising receiving feedback from the user regarding the viewed advertisement.

5. The method of claim 1, further comprising facilitating a connection between users and advertisers.

6. The method of claim 4, further comprising providing a further incentive in response to receiving the feedback.

7. A system, comprising:
a processor;
a memory storing software instructions that when executed by the processor implement a method including
generating a user interface;
displaying an advertisement for viewing by a user via the user interface;
verifying the user's viewing of the advertisement; and
based on the verification, providing an incentive to the user.

8. The system of claim 7, wherein the implemented method further includes verifying the viewing of the advertisement by the user.

9. The system of claim 7, wherein the incentive includes a sweepstakes entry.

10. The system of claim 7, wherein the implemented method further includes receiving feedback from the user regarding the viewed advertisement.

11. The system of claim 10, wherein the implemented method further providing a further incentive in response to receiving the feedback.

12. A computer readable storage medium storing instructions that when executed implement a method, comprising:
receiving a registration by a user;
displaying an advertisement for viewing by the user;
verifying the user's viewing of the advertisement; and
based on the verification, providing an incentive to the user.
